(19) United States
(12) Patent Application Publication
(10) Pub. No.: US 2014/0159857 A1
(43) Pub. Date: Jun. 12, 2014

(54) LOCK CONTROLLER AND ELECTRONIC KEY SYSTEM FOR VEHICLE

(71) Applicants: Koichi KOJIMA, Aichi-ken (JP); TOYOTA JIDOSHA KABUSHIKI KAISHA, Aichi-ken (JP); KABUSHIKI KAISHA TOKAI RIKA DENKI SEISAKUSHO, Aichi (JP)

(72) Inventors: Takashi IEDA, Aichi (JP); Kazuhito YARAGAMI, Aichi (JP); Koichi KOJIMA, Toyota-shi (JP)

(73) Assignees: TOYOTA JIDOSHA KABUSHIKI KAISHA, Aichi-ken (JP); KABUSHIKI KAISHA TOKAI RIKA DENKI SEISAKUSHO, Aichi (JP)

(21) Appl. No.: 14/097,658

(22) Filed: Dec. 5, 2013

(30) Foreign Application Priority Data
Dec. 6, 2012 (JP) 2012-266971

(51) Int. Cl. G07C 9/00

(52) U.S. Cl. CPC G07C 9/00658
USPC 340/5.6

(57) ABSTRACT

A verification result holding unit holds a result of ID verification performed on an electronic key through wireless communication. When an operation control unit detects an operation request signal for a lock mechanism, the operation control unit permits operation of the lock mechanism as long as the verification result holding unit holds a result indicating ID verification accomplishment.

### CROSS-REFERENCE TO RELATED APPLICATIONS

This application is based upon and claims the benefit of priority from prior Japanese Patent Application No. 2012-266971, filed on Dec. 6, 2012, the entire contents of which are incorporated herein by reference.

### BACKGROUND

The present invention relates to a lock controller that controls a lock mechanism for locking a device, which is related to a power port, to a vehicle body.

Vehicles driven by rechargeable batteries, such as a plugin hybrid vehicles and electric vehicles, have become popular. When charging a battery of such a rechargeable battery-driven vehicle, a charge cable is connected to a power port arranged in the body of the vehicle. To prevent the charge cable and electricity from being stolen, the vehicle body may include a charge cable lock device. Japanese Laid-Open Patent Publication Nos. 2009-81917, 2010-4731, and 2011-81952 describes examples of charge cable lock devices that lock a charge cable connected to a power port in cooperation with the locking of a vehicle door, and unlocks the charge cable in cooperation with the unlocking of the vehicle door.

In such a door lock cooperation type charge cable lock device, the person charging the vehicle has to unlock the vehicle door to remove the charge cable from the power port. This person may have to move from the proximity of the power port to the proximity of the vehicle door. In addition to when the vehicle door is locked or unlocked, the door lock device is driven whenever the charge cable is locked or unlocked. Thus, the door lock cooperation type charge cable lock device may shorten the life of the door lock device.

### SUMMARY

One aspect of the present invention is a lock controller for controlling a lock mechanism that locks a device related to a power port of a vehicle. The lock controller includes a verification result holding unit configured to hold a result of ID verification performed on an electronic key through wireless communication. An operation control unit permits operation of the lock mechanism as long as the verification result holding unit holds a result indicating accomplishment of the ID verification when detecting an operation request signal that requests for the lock mechanism to be operated.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of an electronic key system according to one embodiment;

FIG. 2 is a perspective view of a charge cable and a power port; and

FIG. 3 is a flowchart illustrating the control of a lock mechanism that locks the charge cable.

### DESCRIPTION OF EMBODIMENTS

One embodiment of a lock controller will now be described.

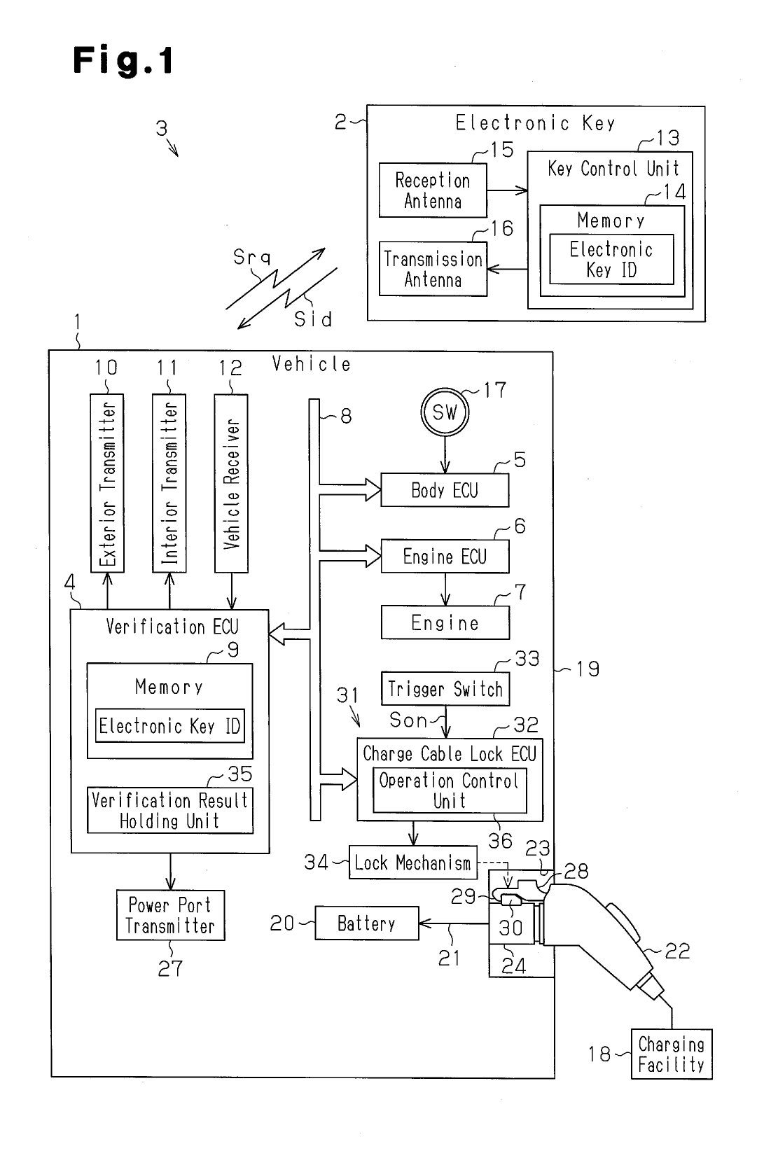

Referring to FIG. 1, a vehicle 1 includes an electronic key system 3. The electronic key system 3 verifies the ID of an electronic key 2 through wireless communication performed between the electronic key 2 and a controller installed in the vehicle 1. The electronic key system 3 is one example of an operation-free key system. In the electronic key system 3, the controller in the vehicle 1 and the electronic key 2 perform bidirectional narrow band communication (smart communication in a communication range of a few meters) to verify the ID of the electronic key (smart verification). When the ID is verified, the electronic key system 3 allows for various operations to be performed on the vehicle 1.

A verification electronic control unit (ECU) 4 that performs ID verification on the electronic key 2, a body ECU 5 that manages power for in-vehicle electric devices, and an engine ECU 6 that controls an engine 7 are allowed to communicate with one another through a bus 8. The verification ECU 4 includes a memory 9 that stores an electronic key ID of the electronic key 2 registered to the vehicle 1. The verification ECU 4 includes an exterior transmitter 10 capable of transmitting radio waves on the low frequency (LF) band outside the vehicle 1, an interior transmitter 11 capable of transmitting radio waves on the LF band inside the vehicle 1, and a vehicle receiver 12 capable of receiving radio waves on the ultrahigh frequency (UHF) band.

The electronic key 2 includes a key control unit 13 that controls the operation of the electronic key 2. The key control unit 13 includes a memory 14 that stores the electronic key ID, which is unique to the electronic key 2. A reception antenna 15, which is capable of receiving LF radio waves, and a transmission antenna 16, which is capable of transmitting UHF radio waves, are connected to the key control unit 13.

When the vehicle 1 is parked, the verification ECU 4 transmits a request signal Srq, which requests for the electronic key ID, out of the vehicle 1 from the exterior transmitter 10. The electronic key 2 that receives the request signal Srq outside the vehicle 1 returns an ID signal Sid, which includes the electronic key ID. When the vehicle receiver 12 receives the ID signal Sid, the verification ECU 4 performs exterior smart verification. When exterior smart verification is accomplished, the verification ECU 4 permits the locking and unlocking of the vehicle doors. The exterior smart verification may include electronic key ID verification, on-board device ID verification, verification of a key number other than the electronic key ID, and challenge-response authentication.

After exterior smart verification is accomplished, the verification ECU 4 transmits a request signal Srq from the interior transmitter 11 into the vehicle 1 to perform interior smart verification in the same manner as the exterior smart verification. When interior smart verification is accomplished, the verification ECU 4 permits power activation (engine starting) in accordance with the operation of an engine switch arranged near the driver seat.

When the vehicle 1 is a rechargeable battery-driven vehicle, such as a plugin hybrid vehicle or an electric vehicle, the vehicle 1 includes a battery 20 charged with a charging facility 18, a charge cable 22, and a charge system 21. The charging facility 18 may be a dedicated charging facility or a household commercial power supply. The vehicle 1 has a vehicle body 19 provided with a power port 23. The charge cable 22 is connected to an inlet 24 arranged in the power port 23. The charge cable 22 is one example of a device related to the power port 23.

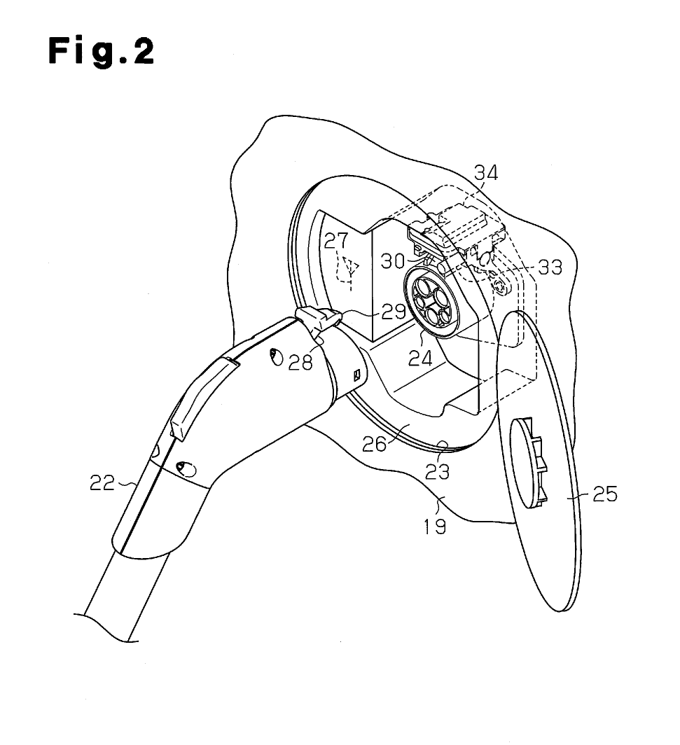

In the example shown in FIG. 2, the power port 23 is closed by a lid 25. When the lid 25 is open, the power port 23 and the inlet 24 is exposed from the vehicle body 19. The lid 25 and the inlet 24 are coupled to a lid box 26 arranged, for example, in the power port 23. The various peripheral components of the power port 23 may be coupled to the lid box 26. A power port transmitter 27 (transmission antenna) is arranged in the lid box 26 to transmit LF radio waves to the vicinity of the power port 23.

The charge cable 22 is provided with a pivotal arm 28 that includes a distal hook 29. When the charge cable 22 is connected to the inlet 24, the distal hook 29 is engaged with a projection 30 of the inlet 24. This fixes the charge cable 22 to the inlet 24.

A charge cable lock system 31 will now be described. In the example shown in FIG. 1, the charge cable lock system 31 includes a lock mechanism 34, a charge cable lock ECU 32, and a trigger switch 33. The lock mechanism 34 locks the charge cable 22 connected to the inlet 24. The charge cable lock ECU 32 controls the operation of the lock mechanism 34. The trigger switch 33 is operated to lock and unlock the charge cable 22 by a person who is charging the battery 20 and who may be the user of the vehicle 1. In one example, the lock mechanism 34 may include a lock pin, which is movable between a lock position and an unlock position, and an actuator such as a motor, which moves the lock pin. When the lock pin is located at a lock position, the lock pin pushes the distal hook 29 of the pivotal arm 28 from above and locks the charge cable 22 to the inlet 24. When the lock pin is located at an unlock position, the pivotal arm 28 is pivotal toward the upper side. This allows for removal of the charge cable 22 from the inlet 24.

A verification result holding unit 35 holds the result of the electronic key ID verification performed to lock or unlock the vehicle doors (exterior smart verification result). The verification result holding unit 35 may be arranged in, for example, the verification ECU 4. Preferably, the verification result holding unit 35 holds a result indicating accomplishment of the electronic key ID verification for a predetermined effective period from when the electronic key ID is verified. For example, the verification result holding unit 35 may set a verification accomplishment flag indicating accomplishment of the electronic key ID verification to the verification result holding unit 35 or the memory 9.

The trigger switch 33 is operated by, for example, the person charging the battery 20 to output an operation request signal Son that requests for the lock mechanism 34 to be operated. The charge cable lock ECU 32 includes an operation control unit 36 that controls the operation of the lock mechanism 34. When receiving the operation request signal Son from the trigger switch 33, the operation control unit 36 checks the exterior smart verification result held by the verification result holding unit 35. The operation control unit 36 controls the operation of the lock mechanism 34 based on the checked verification result.

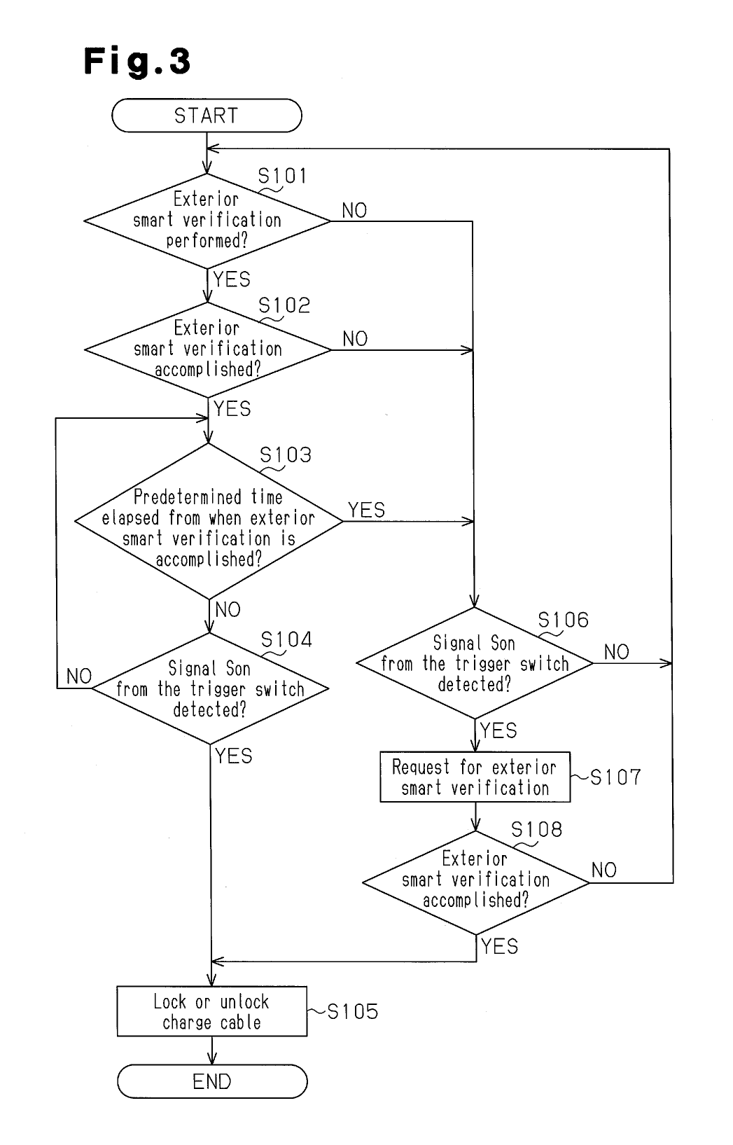

With reference to FIG. 3, the operation of the charge cable lock system 31 will now be described.

In step S101, the verification ECU 4 performs exterior smart verification, and the operation control unit 36 determines whether or not the verification ECU 4 has performed exterior smart verification. For example, when exterior smart verification for locking or unlocking the vehicle door has been performed, the operation control unit 36 proceeds to step S102. When exterior smart verification has not been performed, the operation control unit 36 proceeds to step S106.

In step S102, the operation control unit 36 determines whether or not the exterior smart verification performed by the verification ECU 4 has been accomplished. When the exterior smart verification has been accomplished, the operation control unit 36 proceeds to step S103. When the exterior smart verification has not been accomplished, the operation control unit 36 proceeds to step S106. In one example, when the exterior smart verification is accomplished, the verification result holding unit 35 may, for example, set a verification accomplishment flag to the verification result holding unit 35 or the memory 9 for a predetermined effective period from when exterior smart verification is accomplished.

In step S103, the operation control unit 36 determines whether or not a predetermined time (effective period) has elapsed from when the exterior smart verification is accomplished. In one example, the operation control unit 36 determines whether or not the verification accomplishment flag is set in the verification result holding unit 35 or the memory 9. When the predetermined time has not elapsed, the operation control unit 36 proceeds to step S104. When the predetermined time has elapsed, the operation control unit 36 proceeds to step S106.

In step S104, the operation control unit 36 determines whether or not an operation request signal Son has been received from the trigger switch 33. The operation request signal Son requests for the charge cable 22 to be locked or unlocked. Receipt of the operation request signal Son indicates whether or not the person charging the battery 20 has operated the trigger switch 33 to lock or unlock the charge cable 22. If the operation request signal Son is received from the trigger switch 33 within a predetermined time (effective period) from when the exterior smart verification is accomplished, the operation control unit 36 proceeds to step S105. When the operation request signal Son is not received from the trigger switch 33 within the predetermined time (effective period), the operation control unit 36 returns to step S103 and waits until the person performing the charging operates the trigger switch 33.

In step S105, the operation control unit 36 provides the lock mechanism 34 with a switch signal or an activation signal in accordance with the operation request signal Son to lock or unlock the charge cable 22. For example, when the charge cable 22 is unlocked, the operation control unit 36 activates the lock mechanism 34 and locks the charge cable 22. When the charge cable 22 is locked, the operation control unit 36 activates the lock mechanism 34 and unlocks the charge cable 22.

In step S106, the operation control unit 36 determines whether or not the operation request signal Son has been received from the trigger switch 33. For example, if the operation request signal Son is received from the trigger switch 33 when the verification accomplishment flag is not set (NO in S101 or S102 or YES in S103), the operation control unit 36 proceeds to step S107. If not, the operation control unit 36 proceeds to step S101.

In step S107, the operation control unit 36 outputs a signal that requests for exterior smart verification to be performed (ID verification request signal). In response to the ID verification request signal, the verification ECU 4 performs exterior smart verification. For example, when the verification accomplishment flag is not set, the verification ECU 4 performs smart verification with the power port transmitter 27 that forms a communication area only in the vicinity of the power port 23 (power port vicinity smart verification).

In step S108, the operation control unit 36 determines whether or not the power port vicinity smart verification performed by the verification ECU 4 has been accomplished. When the power port vicinity smart verification has been accomplished, in step S105, the operation control unit 36 activates the lock mechanism 34. When the power port vicinity smart verification has not been accomplished, the operation control unit 36 returns to step S101.

The illustrated embodiment has the advantages described below.

(1) The verification result holding unit 35 holds a result indicating that exterior smart verification has been accomplished. If the trigger switch 33 is not operated within the predetermined period from when the electronic key system 3 locks or unlocks the door in response to accomplishment of the exterior smart verification, the verification ECU 4 does not perform additional exterior smart verification, and the operation control unit 36 activates the lock mechanism 34 to lock or unlock the charge cable 22. In this manner, if the verification result holding unit 35 holds a result indicating that smart verification has been accomplished when the trigger switch 33 is operated, the operation control unit 36 readily activates the lock mechanism 34 by checking only the result indicating electronic key ID verification accomplishment. Thus, the charge cable 22 is smoothly locked and unlocked.

(2) As long as the trigger switch 33 is operated within the predetermined time from when the exterior smart verification is accomplished, the lock mechanism 34 is readily activated to lock or unlock the charge cable 22. This improves the response to an operation of the trigger switch 33.

(3) A result indicating that exterior smart verification has been accomplished is held within the predetermined time. This prevents or reduces unauthorized unlocking of the charge cable 22.

(4) If the trigger switch 33 is operated after the predetermined time elapses from when the exterior smart verification is accomplished, the operation control unit 36 requests for smart verification (power port vicinity smart verification) to be performed. When smart verification is performed in response to the request, the operation control unit 36 may activate the lock mechanism 34 to lock or unlock the charge cable 22. Thus, as long as the person charging the battery 20 is carrying the authentic electronic key 2, the charge cable 22 may be locked or unlocked even after the predetermined time elapses or when exterior smart verification is not accomplished beforehand. Such a configuration is convenient.

(5) The verification result holding unit 35 holds the exterior smart verification result. Thus, the person charging the battery 20, who may be the user of the vehicle 1, may smoothly perform the sequence of tasks that include exiting the vehicle 1, locking the vehicle doors, and locking the charge cable 22 outside the vehicle 1.

(6) The lock mechanism 34 is configured to lock the charge cable 22. Thus, the user can smoothly lock and unlock the charge cable 22.

It should be apparent to those skilled in the art that the present invention may be embodied in many other specific forms without departing from the spirit or scope of the invention. Particularly, it should be understood that the present invention may be embodied in the following forms.

The operation control unit 36 and the verification result holding unit 35 may configure the controller of the electronic key system 3. For example, the charge cable lock ECU 32 may be incorporated in the verification ECU 4. When the operation control unit 36 is allowed to access the verification result holding unit 35 and check the ID verification result of the electronic key 2, the operation control unit 36 and the verification result holding unit 35 may be arranged in the same controller, for example, the charge cable lock ECU 32 or the verification ECU 4. The charge cable lock ECU 32 and/or the verification ECU 4 may include computer-readable instructions to be executed by the operation control unit 36. In some embodiment, the instructions may be stored in a computer-readable storage device, such as a magnetic disk or optical disk, coupled to or accessed by the operation control unit 36.

The trigger switch 33 may be a lock switch and an unlock switch respectively outputting a lock request signal and an unlock request signal as the operation request signal Son for the lock mechanism 34.

The verification result holding unit 35 may hold, for example, an interior smart verification result. In a further example, the verification result holding unit 35 holds the verification result of the ID verification (wireless verification) performed by the wireless key system.

The smart verification performed after the predetermined time elapses (e.g., S107 in FIG. 3) may be exterior smart verification performed only in the vicinity of the power port 23 with the power port transmitter 27 or normal exterior smart verification performed with the exterior transmitter 10.

The operation request signal Son for the lock mechanism 34 does not have to be output from the trigger switch 33. For example, the operation request signal Son for the lock mechanism 34 provided to the operation control unit 36 may be a sensor signal output from a sensor (e.g., strain sensor or contact sensor) arranged in the inlet 24 to detect connection or/and removal or the charge cable 22 to and from the inlet 24.

In addition to the smart verification result, the verification result holding unit 35 may hold an ID verification result (wireless verification) performed by a wireless key system as long as the result is obtained when electronic key ID verification is performed through wireless communication. The wireless key system verifies an electronic key ID through narrowband wireless communication started by the electronic key 2.

The structure of the lock mechanism 34 is not limited to the foregoing description. In a lock mechanism of a further example, a lock pin is engaged with a recess of the charge cable 22 to lock the charge cable 22. The direction in which the lock mechanism 34 is coupled is not particularly limited.

The control of the lock mechanism 34 may be performed only when locking or unlocking the charge cable 22.

In lieu of or in addition to the charge cable 22, the lock mechanism 34 may, for example, lock and unlock the lid 25.

The device related with the power port 23 is not limited to the charge cable 22 and the lid 25 and may be a device located near the power port 23 at least when charging is performed.

The present examples and embodiments are to be considered as illustrative and not restrictive, and the invention is not to be limited to the details given herein, but may be modified within the scope and equivalence of the appended claims.

1. A lock controller for controlling a lock mechanism that locks a device related to a power port of a vehicle, the lock controller comprising:
a verification result holding unit configured to hold a result of ID verification performed on an electronic key through wireless communication; and
an operation control unit that permits operation of the lock mechanism as long as the verification result holding unit holds a result indicating accomplishment of the ID verification when detecting an operation request signal that requests for the lock mechanism to be operated.

2. The lock controller according to claim 1, wherein the verification result holding unit holds a result of the ID verification for a predetermined time from when the ID verification is accomplished.

3. The lock controller according to claim 1, wherein the operation control unit further
requests for the ID verification to be performed on the electronic key when the verification result holding unit does not hold a result indicating accomplishment of the ID verification, and
permits operation of the lock mechanism when a result of the ID verification performed on the electronic key in response to the request indicates accomplishment.

4. The lock controller according to claim 1, wherein the ID verification is an exterior verification that permits or performs locking or unlocking of a vehicle door, and the exterior verification is performed based on an electronic key ID received through wireless communication from the electronic key that is located outside the vehicle.

5. The lock controller according to claim 1, wherein the device related to a power port of a vehicle includes a charge cable used to charge a battery of the vehicle.

6. The lock controller according to claim 1, wherein the device related to a power port of a vehicle includes a lid that closes the power port.

7. The lock controller according to claim 1, wherein the operation control unit is configured to activate the lock mechanism in accordance with the operation request signal if the verification result holding unit is already holding a result indicating accomplishment of the ID verification when the operation request signal for the lock mechanism is detected.

8. The lock controller according to claim 1, wherein
the operation control unit is connected to a trigger switch that outputs the operation request signal for the lock mechanism when operated by a person performing charging; and
the operation control unit is configured to activate the lock mechanism in accordance with the operation request signal when a result indicating accomplishment of the ID verification is obtained before the trigger switch is operated.

9. An electronic key system arranged in a vehicle including a battery, an inlet, a lock mechanism that locks a charge cable to the inlet, and a trigger switch that outputs an operation request signal requesting for the lock mechanism to operate when operated by a person performing charging, the electronic key system comprising:
a receiver that receives an electronic key ID from an electronic key through wireless communication; and
a controller connected to the lock mechanism, the trigger switch, and the receiver, wherein the controller includes
instructions configured to verify the electronic key ID received from the receiver,
instructions configured to hold, when verification of the electronic key ID is accomplished, a verification result indicating the accomplishment and output a door lock signal or door unlock signal, and
instructions configured to activate the lock mechanism in accordance with the operation request signal when the controller receives the operation control signal from the trigger switch when the controller is already holding a verification result indicating the accomplishment.

10. The electronic key system according to claim 9, wherein
the controller is configured to hold a verification result indicating accomplishment for a predetermined time from when the verification is accomplished, and
the controller includes instructions configured to activate the lock mechanism in accordance with the operation request signal when receiving the operation request signal after the verification is accomplished but before the predetermined time elapses.

11. The electronic key system according to claim 9, wherein the controller further includes
instructions configured to perform ID verification on the electronic key in response to the operation request signal if a verification result indicating accomplishment is not held when the operation request signal is received from the trigger switch,
instructions configured to activate the lock mechanism in accordance with the operation request signal when accomplishing the ID verification of the electronic key performed in response to the operation request signal from the trigger switch, and
instructions configured not to activate the lock mechanism when the ID verification performed on the electronic key in response to the operation request signal from the trigger switch is not accomplishing.

12. A vehicle comprising:
a power port that receives a charge cable used to charge a battery;
a power port lid that closes the power port;
a lock mechanism configured to lock and unlock one or both of the charge cable and the power lid;
a trigger switch operated by a person charging the battery to output an operation request signal that requests for one of the charge cable and the power port lid to be locked or unlocked; and
the electronic key system according to claim 9.

13. The vehicle according to claim 12, further comprising a power port transmitter that forms a communication area in the vicinity of the power port to verify an electronic key ID, wherein
the controller is configured to hold a verification result indicating accomplishment for a predetermined time from when the verification is accomplished, and
the controller includes
instructions configured to perform ID verification on an electronic key with the power port transmitter when the controller receives the operation request signal under a situation in which the controller is not holding a verification result indicating accomplishment, and
instructions configured to activate the lock mechanism when the result of the ID verification performed on the electronic key in response to the request indicates accomplishment.
